(19) United States
(12) Patent Application Publication
(10) Pub. No.: US 2023/0140598 A1
(43) Pub. Date: May 4, 2023

(54) Method, System, Computer Program and Computer-Readable Data Storage Medium for Processing Vehicle Data

(71) Applicant: Bayerische Motoren Werke Aktiengesellschaft, Muenchen (DE)

(72) Inventors: Stefan Herrmann, Muenchen (DE); Philipp Reinisch, Kirchseeon (DE); BernharD Schlegel, Muenchen (DE)

(21) Appl. No.: 17/910,736

(22) PCT Filed: Jan. 19, 2021
(86) PCT No.: PCT/EP2021/050995

§ 371 Date: Sep. 9, 2022

(30) Foreign Application Priority Data
Mar. 19, 2020 (DE) 10 2020 107 551.0

(51) Int. Cl. G07C 5/00; G07C 5/08

(52) U.S. Cl. CPC G07C 5/008; G07C 5/0841

(57) ABSTRACT

A method for processing vehicle data includes receiving, by a computer system, via a first data transmission channel, a first subset of vehicle data recorded in a vehicle. The method also includes receiving, by the computer system, via a second data transmission channel, a second subset of the vehicle data. The method further includes selecting, by way of the computer system, data that are to be processed from the first and the second subset of the vehicle data on the basis of at least one predetermined selection criterion.

The present application is the U.S. national phase of PCT Application PCT/EP2021/050995 filed on Jan. 19, 2021, which claims priority of German patent application No. 102020107551.0 filed on Mar. 19, 2020, which is incorporated herein by reference in its entirety.

### TECHNICAL FIELD

The present disclosure relates to a method for processing vehicle data. The disclosure furthermore relates to a system for processing vehicle data, to a computer program and to a computer-readable storage medium.

### BACKGROUND

In modern vehicles, large amounts of data are recorded nowadays. In particular in test vehicles, data are recorded in the region of several gigabytes or even terabytes in a relatively short period of time. Vehicle data of this kind are, for example, diagnostic data, error messages in the vehicle, other measurement data in and around the vehicle, or recordings of data bus communications in the vehicle. These are merely a few examples of a multiplicity of possible vehicle data which can be recorded during a journey or else while the vehicle is stationary.

Due to the large amount of vehicle data, transmitting these vehicle data for the purpose of evaluating the data by way of an external computer system is not unproblematic. At the same time, it is desirable to evaluate the vehicle data ideally without any unnecessary time delay.

### SUMMARY

The object of the disclosure is to describe a method, a system, a computer program and a computer-readable storage medium for processing vehicle data, with which large amounts of vehicle data can be evaluated without any unnecessary time delay.

The above-described object, as well as others, are achieved by the features and advantageous configurations described herein.

A first aspect of the disclosure is a method for processing vehicle data that includes receiving, by a computer system, via a first data transmission channel, a first subset of vehicle data recorded in a vehicle. The method also includes receiving, by the computer system, via a second data transmission channel, a second subset of the vehicle data. The method further includes selecting, by way of the computer system, data that are to be processed from the first and the second subset of the vehicle data on the basis of at least one predetermined selection criterion.

It is advantageous here that vehicle data, which are transmitted to the computer system via different data transmission channels, can be selected in a need-specific manner by stipulating at least one predetermined selection criterion. In this way, storing unnecessary data can be avoided, which results in storage space optimization. Furthermore, processes for analyzing the data can, for example, also be accelerated through suitable selection of the vehicle data.

The recorded vehicle data are, for example, measurement data obtained in the vehicle, error data generated by components of the vehicle and/or by software used in the vehicle, recorded data from data buses used in the vehicle and/or other data recorded or generated in or around the vehicle.

Receiving the data via different data transmission channels has the advantage that an appropriate transmission channel can be used according to the type of data. Important data can be received, for example, via a data transmission channel that has a fast data transmission rate, whereas other data can be received via a data transmission channel which can easily transmit large amounts of data. After being selected, the data that are to be processed are, for example, stored, analyzed or forwarded.

In at least one configuration, the first data transmission channel is a streaming layer channel via which the first subset of the vehicle data is received wirelessly. In particular, the streaming layer channel is established via a radio network having a large-area network coverage in a region in which the vehicle is moving, for example a mobile radio network. The second data transmission channel is a batch layer channel, by means of which the second subset of the vehicle data is received via a local data link.

The streaming layer channel, via which the data are received wirelessly, allows the vehicle data to be transmitted to the computer system promptly and quickly in terms of acquiring the data. In contrast, the batch layer channel allows large amounts of data to be transmitted to the computer system. Although this happens with a significantly longer time delay compared to the streaming layer channel, it additionally guarantees a significantly higher reliability than the streaming layer channel.

For the streaming layer channel, a radio module, such as for example a GSM (Global System for Mobile communications) module, is, for example, used for wirelessly transmitting the data via a mobile radio network. The local data link is, for example, a wired data transmission, for example via a serial or parallel interface, or a local wireless data transmission via local wireless networks, such as a WLAN, for example.

In at least one configuration, the method further comprises the step:
receiving, by the computer system, at least one third subset of the vehicle data via at least one third data transmission channel.

This third data transmission channel is, for example, likewise a streaming layer channel.

In at least one configuration, the first subset and the second subset of the vehicle data comprise at least partially identical data types. When using the third data transmission channel, the at least one third subset and the second and/or the first subset of the vehicle data likewise comprise at least partially identical data types.

In this context, identical data types are considered to be data which, regarding evaluation of the corresponding data, deliver interchangeable information about identical elements of the vehicle. Identical data types here are, for example, identical data having identical information content and identical metadata, or, for example, data that are stored differently and/or transmitted differently but which relate to an identical element in a vehicle or an identical event during operation of a vehicle, differing, however, in their data quality, data resolution or in their metadata, for example.

In at least one configuration, the at least one predetermined selection criterion is based on requirements regarding an availability of the vehicle data and/or a temporal sequence of the transmission of the vehicle data and/or a quality of the vehicle data and/or a quality of an analysis of the vehicle data.

When selecting the data that are to be processed based on requirements regarding the availability, it is advantageous that in this way it can be ensured that as far as possible all of the received data at the computer system are selected for further processing of the data. At the same time, however, storing identical or interchangeable data twice can thus also be prevented. This results in storage space optimization in the computer system.

With selection criteria regarding the temporal sequence of the transmission of the vehicle data, preference can be given to selecting, for example, data which are transmitted quickly from the vehicle to the computer system. This is particularly advantageous for data which are intended to be evaluated promptly in terms of their acquisition.

With selection criteria regarding the quality of the vehicle data or the quality of the analysis of the vehicle data, preference can be given, for example, to data which are transmitted more slowly but because of this have a better data quality, for example due to more extensive metadata or due to a better resolution. This is particularly advantageous for data which require accurate and detailed analysis.

According to a second aspect, a computer system is configured to receive, via a first data transmission channel, a first subset of vehicle data recorded in a vehicle. The computer system is further configured to receive, via a second data transmission channel, a second subset of the vehicle data and to select data that are to be processed from the first and the second subset of the vehicle data on the basis of at least one predetermined selection criterion.

According to a third aspect, a computer program comprises instructions which, when the computer program is executed by a computer, cause the computer to carry out the method for processing vehicle data when said computer program is executed on a data processing device.

According to a fourth aspect, a computer program product comprises an executable program code, wherein the program code, when executed by a data processing device, executes the method for processing vehicle data.

The computer program product in particular comprises a medium which can be read by the data processing device and on which the program code is stored.

Configurations of the first aspect can also correspondingly be available and have corresponding effects for the second, third and fourth aspect, and vice versa.

Exemplary embodiments are explained in more detail below on the basis of the schematic drawings.

### BRIEF DESCRIPTION OF THE DRAWINGS

FIG. 1 shows a schematic illustration of a system for processing vehicle data according to one exemplary embodiment, and

FIG. 2 shows a flowchart of a method for processing vehicle data according to one exemplary embodiment.

### DETAILED DESCRIPTION

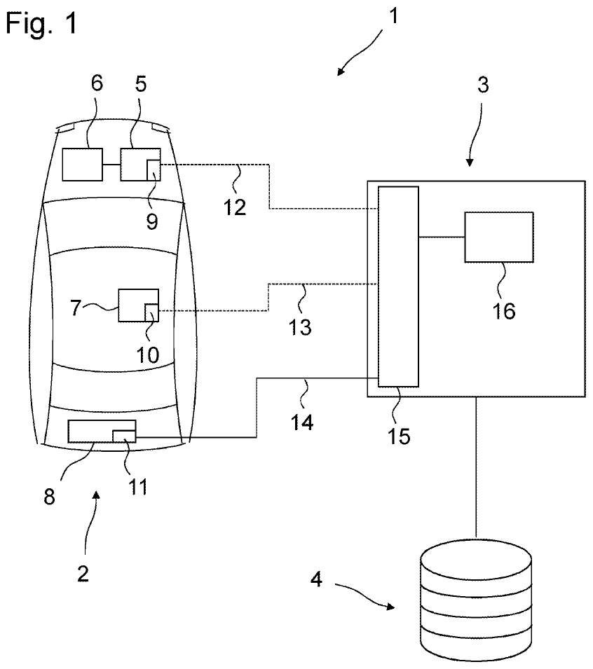

FIG. 1 shows a system 1 for processing vehicle data according to one exemplary embodiment. The system 1 comprises a vehicle 2, a computer system 3 and a storage device 4. In this exemplary embodiment, the vehicle 2 is a passenger car but can also be any other vehicle. In this exemplary embodiment, the computer system 3 is a server which is connected to the storage device 4. Alternatively, the computer system 3 can however also be a computer cluster or any other computer system.

The vehicle 2 has an on-board measuring device 5, i.e. a measuring device 5 located on or in the vehicle 2, which is used to record various measurement data of the vehicle 2. For example, data of a motor 6 of the vehicle 2 and/or other vehicle data of the vehicle 2 are recorded by the measuring device 5.

Furthermore, the vehicle 2 has a vehicle diagnostic system 7 which is used to record further various vehicle data, such as, for example, a data bus communication in the vehicle 2. The vehicle diagnostic system 7 is, for example, a so-called over-the-air logger.

Moreover, the vehicle 2 has a data logger 8 which monitors and records all of the data generated in the vehicle 2 or received by the vehicle 2. These include measurement data arising in the vehicle 2, data bus communications, error messages, etc. In the exemplary embodiment shown here, all of the data acquired by the measuring device 5 and the vehicle diagnostic system 7 are also acquired in the vehicle 2 by way of the data logger 8—along with data of other elements not shown here.

In this exemplary embodiment, the on-board measuring device 5 has a first GSM (Global System for Mobile communications) module 9 which can log in to a mobile radio network and transmit or receive data via this mobile radio network. The vehicle diagnostic system 7 has a second GSM module 10 which corresponds in its operation to the first GSM module 9. The data logger 8 has a hard disk 11 on which the data collected by the data logger 8 are stored. Alternatively, the data logger 8 can also have another storage device.

In this exemplary embodiment, the hard disk 11 has a data interface having a plug connector via which the hard disk 11 in this exemplary embodiment is separably connected to the data logger 8 and, when the hard disk 11 is separated from the data logger 8, can be connected to another computer system, for example the computer system 3. Alternatively, a computer system can be connected to the plug connector of the hard disk 11, for example, via a wire, for example when the hard disk 11 is integrated into the data logger 8.

A first streaming layer channel 12 to the computer system 3 is established via the first GSM module 9. Via this first streaming layer channel 12, the on-board measuring device 5 sends, by means of the first GSM module 9, the data recorded by the on-board measuring device 5 to the computer system 3. In this exemplary embodiment, this happens immediately or with a delay of up to a few minutes after recording the corresponding data by way of the measuring device 5.

Analogously, via the second GSM module 10, the data recorded by the vehicle diagnostic system 7 are sent via a second streaming layer channel 13 to the computer system 3. This likewise happens immediately or with a delay of up to a few minutes after recording the data by way of the vehicle diagnostic system 7.

In this exemplary embodiment, the data recorded by the data logger 8 and stored in the hard disk 11 are sent to the computer system 3 via the above-described interface via a batch layer channel 14. This happens at least partially with a time delay of several hours, days or even weeks after acquiring the corresponding data by way of the data logger 8. For this purpose, the hard disk 11 is connected to the computer system 3 directly or via a wire, for example. Alternatively, the hard disk 11 can also for this purpose be connected to a further computer system not shown here, from which the data of the hard disk 11 are read out and subsequently, for example via the Internet, are sent to the computer system 3.

In the exemplary embodiment shown here, important data are recorded by the measuring device 5 and the vehicle diagnostic system 7 for a vehicle analysis in each case, in the case of which it is advantageous to send these data as far as possible promptly to the computer system 3 for further processing or analysis. The described streaming layer channels 12 and 13 are the fastest option for this in the system 1.

During a journey of the vehicle 2 through a region which is not covered by a mobile radio network, for example in a tunnel, it can however be the case that data which are intended to be sent to the computer system 3 from the measuring device 5 or from the vehicle diagnostic system 7 go missing or are transmitted only with errors. Other impairments of the streaming layer channels 12 and 13 can also result in data going missing or in their quality being impaired. Moreover, it is possible, so as not to overload the streaming layer channels 12 and 13, to transmit the data acquired by the measuring device 5 and the vehicle diagnostic system 7 only with a low resolution or only partially.

The data acquired by the data logger 8 comprise all the vehicle data of the vehicle 2, i.e. therefore also those data which were recorded by the measuring device 5 and the vehicle diagnostic system 7. When all of the data are transmitted from the hard disk 11 to the computer system 3, it can thus be the case that data of the same type, which were already sent to the computer system 3 via the streaming layer channels 12 and 13, are read out again from the hard disk 11. However, it can be the case here that the corresponding data are present on the hard disk 11 with a better resolution, better quality or to a greater extent, e.g. provided with more extensive metadata.

The computer system 3 has a backend module 15 which acts as a read-in layer (also known as an “ingestion layer”) for all the data received via the first streaming layer channel 12, the second streaming layer channel 13 and the batch layer channel 14.

The backend module 15 stores predetermined selection criteria, on the basis of which the backend module 15 makes a selection as to which of the data sent via the three channels 12, 13, 14 mentioned should be processed or stored or forwarded. The selected data are then analyzed in an analysis module 16 of the computer system 3 and/or stored in the storage device 4.

In the exemplary embodiment shown here, criteria based on an availability of the data, based on a quality of the data and based on a quality of an analysis of the data, which are received via the three channels 12, 13, 14, are selected as selection criteria, for example.

Regarding the selection criterion of the availability, it is checked, by way of the backend module 15, for example, whether the received data are already present. This relates in particular to the data that were read in via the batch layer channel 14, since it can be the case that parts of the data stored in the hard disk 11 were already read in via the first or the second streaming layer channel 12, 13. If the data are already present, further processing and/or storage of the data can be dispensed with. If the corresponding data are still not present, the corresponding data can be processed or stored. In this way, storing identical data twice is avoided, which results in storage space optimization in the storage device 4.

Furthermore, selection criteria can be based, for example, on a speed of the data availability. For example, data which are transmitted without a significant time delay, i.e. which are transmitted via the streaming layer channels 12, 13, can be preferred to corresponding data which are transmitted via the batch layer channel 14 with a time delay in terms of their acquisition in the vehicle 2. This allows faster data processing of the data sent via the streaming layer channels 12, 13. However, if a data quality for processing the corresponding data in the computer system 3 is of significant importance, selection criteria regarding the quality or validity of the received data can also be used. For example, preference can be given in principle to data of better quality. Thus, when receiving the respective data, it can be checked in the backend module 15 whether corresponding data are already present in sufficient quality, or whether qualitatively better data should be selected for the further processing, when the data received via the batch layer channel 14 correspond to a data type of data that have already been received but have a better quality. This can correspondingly apply when the collected data are already analyzed in the vehicle 2 and sent to the computer system 3, also for a quality of the analyses of the data.

The selection criteria mentioned here are merely examples of a multiplicity of possible selection criteria. The selection criteria can also be used together for selecting the data that are to be processed.

By way of the above-described system, storage space optimization in the storage device 4 and faster data processing in the computer system 3 are achieved. Overall, a data basis for an analysis of the vehicle data collected in the vehicle 2 is thus improved.

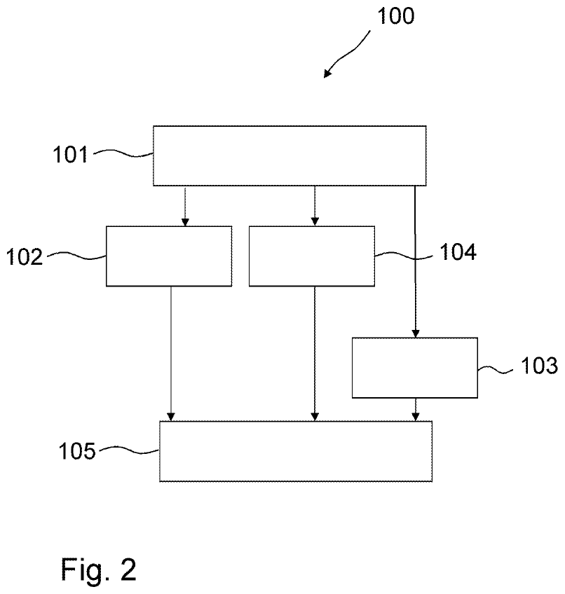

FIG. 2 shows a flowchart of a method 100 for processing vehicle data according to one exemplary embodiment.

In a first step 101, vehicle data are recorded by means of a data processing device of a vehicle. For this purpose, for example, the devices described in relation to FIG. 1, such as the on-board measuring device 5, the vehicle diagnostic system 7 and the data logger 8, are used.

In a further step 102, a first subset of the vehicle data is received by a computer system via a first data transmission channel. The first subset of the vehicle data is, for example, all or some of the data collected by the above-described measuring device 5. Alternatively, another selection of data can also be transmitted as first subset.

The first subset is, for example, transmitted to the computer system via a first streaming layer channel, as described in relation to FIG. 1.

In further steps 103 and 104, a second and a third subset of the vehicle data are received by the computer system via a second and a third data transmission channel. The second subset of the vehicle data is, for example, all of the data acquired in the vehicle. This corresponds to the data which are recorded by the data logger 8 described in relation to FIG. 1. The third subset is, for example, the data which are recorded by the vehicle diagnostic system 7 described in relation to FIG. 1. Alternatively, another selection of data can also of course be transmitted as second and third subset.

The second subset is, for example, transmitted to the computer system via a batch layer channel, as described in relation to FIG. 1. The third subset is, for example, transmitted to the computer system via a second streaming layer channel, as described in relation to FIG. 1.

The steps 102, 103 and 104 can proceed at the same time or at different times. The steps 102, 103 and 104 can also be carried out continuously or repeatedly. All or some of the steps 102, 103 and 104 can also be carried out in parallel with the first step 101.

In a further step 105, by way of the computer system, data that are to be processed are selected from the first, the second and the third subset of the vehicle data on the basis of at least one predetermined selection criterion. The selected data are then analyzed, stored, forwarded or otherwise processed.

### LIST OF REFERENCE SIGNS

1 system
2 vehicle
3 computer system
4 storage device
5 measuring device
6 motor
7 vehicle diagnostic system
8 data logger
9 first GSM module
10 second GSM module
11 hard disk
12 first streaming layer channel
13 second streaming layer channel
14 batch layer channel
15 backend module
16 analysis module
100 method
101-105 method steps

1.-10. (canceled)

11. A method for processing vehicle data, the method comprising the following steps:
receiving, by a computer system, via a first data transmission channel, a first subset of vehicle data recorded in a vehicle,
receiving, by the computer system, via a second data transmission channel, a second subset of the vehicle data,
selecting, by way of the computer system, data that are to be processed from the first and the second subset of the vehicle data on the basis of at least one predetermined selection criterion.

12. The method as claimed in claim 11, wherein:
the first data transmission channel is a streaming layer channel via which the first subset of the vehicle data is received wirelessly, and
the second data transmission channel is a batch layer channel in which the second subset of the vehicle data is received via a local data link.

13. The method as claimed in claim 12, further comprising the step:
receiving, by the computer system, at least one third subset of the vehicle data via at least one third data transmission channel.

14. The method as claimed in claim 13, wherein the at least one third data transmission channel is at least one further streaming layer channel via which the at least one third subset of the vehicle data is received wirelessly.

15. The method as claimed in claim 14, wherein the at least one predetermined selection criterion is based on requirements regarding an availability of the vehicle data and/or a temporal sequence of the transmission of the vehicle data and/or a quality of the vehicle data and/or a quality of an analysis of the vehicle data.

16. The method as claimed in claim 12, wherein the first subset and the second subset of the vehicle data comprise at least partially identical data types.

17. The method as claimed in claim 12, wherein the at least one predetermined selection criterion is based on requirements regarding an availability of the vehicle data and/or a temporal sequence of the transmission of the vehicle data and/or a quality of the vehicle data and/or a quality of an analysis of the vehicle data.

18. The method as claimed in claim 11, further comprising the step:
receiving, by the computer system, at least one third subset of the vehicle data via at least one third data transmission channel.

19. The method as claimed in claim 11, wherein the first subset and the second subset of the vehicle data comprise at least partially identical data types.

20. The method as claimed in claim 11, wherein the first and the second subset of the vehicle data are read in by means of a backend module of the computer system before selecting (104) data that are to be processed.

21. The method as claimed in claim 11, wherein the at least one predetermined selection criterion is based on requirements regarding an availability of the vehicle data and/or a temporal sequence of the transmission of the vehicle data and/or a quality of the vehicle data and/or a quality of an analysis of the vehicle data.

22. A computer system for processing vehicle data, wherein the computer system is configured to:
receive, via a first data transmission channel, a first subset of vehicle data recorded in a vehicle,
receive, via a second data transmission channel, a second subset of the vehicle data, and
select data that are to be processed from the first and the second subset of the vehicle data on the basis of at least one predetermined selection criterion.

23. The computer system as claimed in claim 22, wherein
the first data transmission channel is a streaming layer channel via which the first subset of the vehicle data is received wirelessly, and
the second data transmission channel is a batch layer channel in which the second subset of the vehicle data is received via a local data link.

24. A computer program comprising commands which, when the computer program is executed by a computer, cause the latter to execute the method as claimed in claim 1.

25. The computer program as claimed in claim 24, wherein
the first data transmission channel is a streaming layer channel via which the first subset of the vehicle data is received wirelessly, and
the second data transmission channel is a batch layer channel in which the second subset of the vehicle data is received via a local data link.

26. A computer-readable storage medium on which the computer program as claimed in claim 25 is stored.

27. A computer-readable storage medium on which the computer program as claimed in claim 24 is stored.
